(19) United States
(12) Patent Application Publication
(10) Pub. No.: US 2004/0176143 A1
(43) Pub. Date: Sep. 9, 2004

(54) System and method for wireless collection and presentation of data

(76) Inventors: Bruce A. Willins, East Northport, NY (US); David Hernandez, Westbury, NY (US); Joseph Katz, Stony Brook, NY (US)

Correspondence Address: SYMBOL TECHNOLOGIES INC, LEGAL DEPARTMENT, ONE SYMBOL PLAZA, HOLTSVILLE, NY, 11742, US

(21) Appl. No.: 10/361,716

(22) Filed: Feb. 7, 2003

(51) Int. Cl. H04B 5/00; H04M 1/00

(52) U.S. Cl. 455/569.1; 455/566; 455/41.2

(57) ABSTRACT

Described is a system and method for collecting and presenting data to a user. The system may include a server, a wireless portable data collector arrangement and a wireless portable head mounted display “HMD”. The server includes a memory storing predefined data. The data collector arrangement may include a wireless communication device, a processor, a portable power supply and an input device which collects input data. The processor processes the input data and forwarding the input data to the server using the communication device which communicates with the server via a communication network. The data collector arrangement is situated on the user. The HMD arrangement receives output data and displays at least a portion of the output data. The HMD arrangement communicates with at least one of the server and the data collector using the communication network. The server generates output data as a function of the input data and the predefined data.

### BACKGROUND INFORMATION

Many applications require mobile users to visualize large quantities of data in a hands-free manner. Furthermore, in many vertical applications, information is either obtained directly or indirectly via reference to an automated data collection mechanism such as, for example, a bar code scan, a Radio Frequency Identification Device (“RFID”) tag read, telemetric information, etc.

Today, such applications use either hand-held or wrist-mounted personal digital assistant (“PDA”) devices augmented with peripherals such as laser scanners or imagers. In both instances, at least one hand is required to read the display which obstructs the user from performing other tasks.

Equally problematic is the limitation on the amount of data that may be presented. Increasing the resolution of the display on a hand-held device provides diminishing returns so that the user can no longer resolve fine details when held at comfortable distances (e.g., to avoid eyestrain and to stay in focus). One solution is to increase the geometric field of view (“FoV”) which requires either a physically larger display size or moving the device closer to one's eye. However, increasing screen size results in a unit that is too large and bulky to be considered mobile, and moving the display closer to one's eye creates near-focus and eyestrain.

Several of these issues can be resolved using a conventional head mounted display (“HMD”) which is cabled to a main computer worn on the body (e.g., on a belt). Conventional HMD systems have generally been integrated into helmets, or have been large appendages mounted to forms similar to eyeglasses. However, this creates difficulties since the user many times is physically active during the use of the device. In order to take these difficulties into consideration, the HMD should be mounted in a comfortable, stable and fashionable manner.

Another difficulty with the use of conventional HMD systems arises when attempting to make a wireless high bandwidth link. Generally, the signaling over the cable is high bandwidth, which allows the HMD display to be refreshed from the main computer. The continuous bandwidth for such a link can easily exceed 100 Megabits per second (“Mbps”). For example, a video graphics array display with an 8 bit color requires in excess of 172 Mbps for a 70 Hertz (“Hz”) refresh. To make such a high bandwidth link wireless requires relatively large amounts of power, increasing the size and weight of the device and/or reducing the battery life.

### SUMMARY OF THE INVENTION

The present invention relates to a system and method for collecting and presenting data to a user. The system may include a server, a wireless portable data collector arrangement and a wireless portable head mounted display “HMD”. The server includes a memory storing predefined data. The data collector arrangement may include a wireless communication device, a processor, a portable power supply and an input device which collects input data. The processor processes the input data and forwarding the input data to the server using the communication device which communicates with the server via a communication network. The data collector arrangement is situated on the user.

The HMD arrangement receives output data and displays at least a portion of the output data. The HMD arrangement communicates with at least one of the server and the data collector using the communication network. The server generates the output data as a function of the input data and the predefined data.

### BRIEF DESCRIPTION OF DRAWINGS

FIG. 1 shows an exemplary embodiment of a system according to the present invention;

FIG. 2 shows an exemplary embodiment of a method according to the present invention;

FIGS. 3a and 3b show an exemplary embodiment of a ring scanner according to the present invention;

FIG. 4 shows an exemplary embodiment of a head mounted display according to the present invention; and

FIG. 5 shows an exemplary embodiment of the present invention incorporated with a Radio Frequency Identification Device.

### DETAILED DESCRIPTION

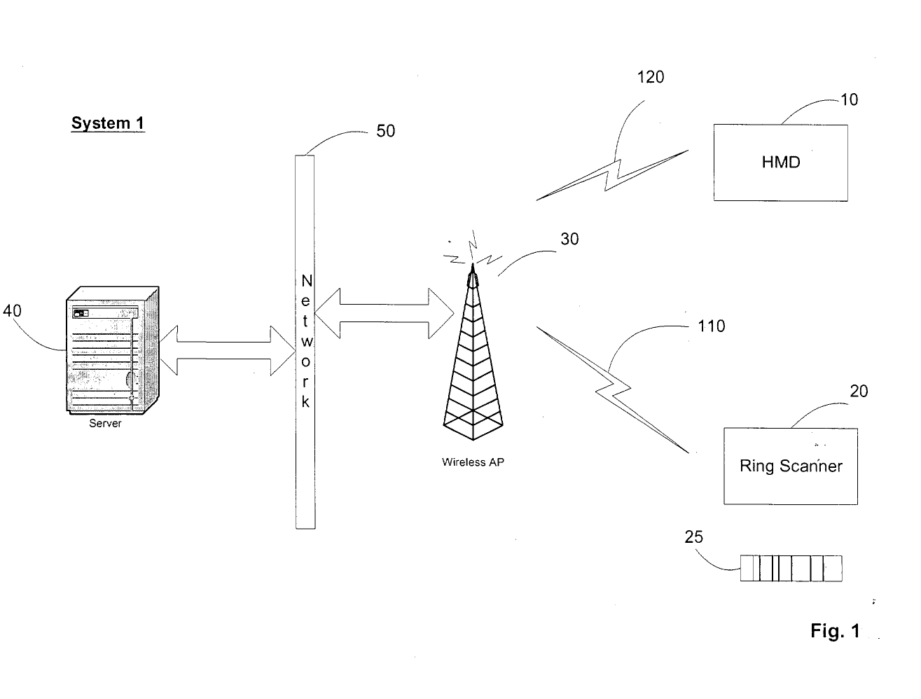

The present invention relates to a system and method for wireless collection and presentation of data. FIG. 1 shows an exemplary embodiment of an HMD system 1 according to the present invention. The HMD system 1 may include an input arrangement (e.g., a wireless ring scanner 20), an output arrangement (e.g., a wireless, lightweight, pseudo-static head mounted display 10), a wireless access point (“AP”) 30, a back-end server 40 and a communication network 50. The ring scanner 20 and the HMD 10 communicate with the server 40 via the AP 30. The AP 30 and the server 40 are linked via the network 50. The communication network 50 may be a local area network (LAN), a wide area network, the Internet, etc.

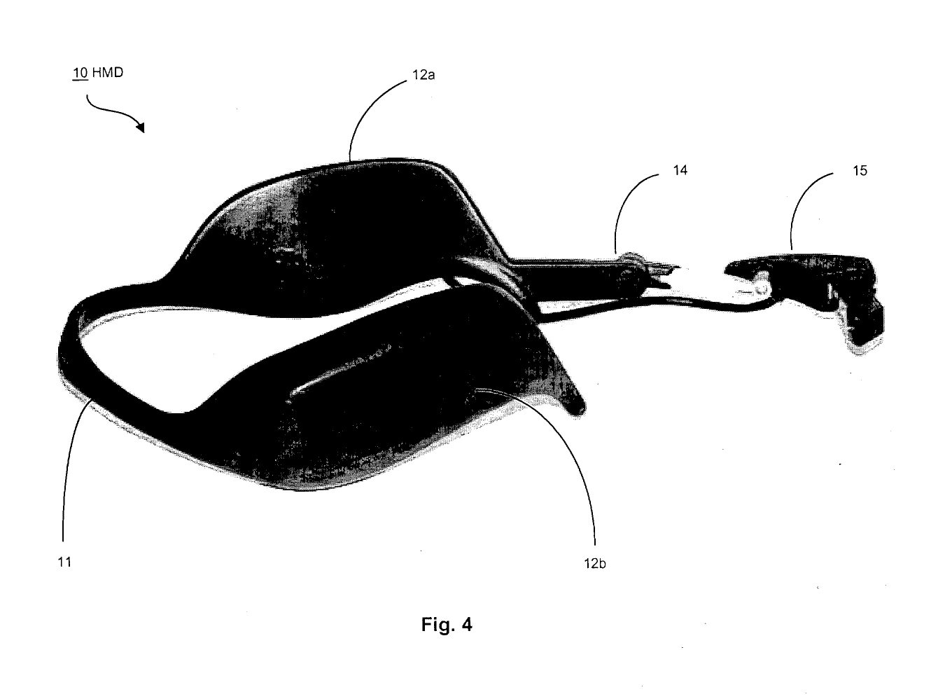

The HMD 10 outputs data by displaying it on a display screen 15 as shown in FIG. 4. The ring scanner 20 acts as an input device by gathering information from external sources (e.g., by scanning input data 25) and/or from user input. For example, the ring scanner 20 may be similar to a bar code scanner and incorporated with a wireless radio with Bluetooth™ technology or IEEE 802.11b technology. Those skilled in the art will recognize that the ring scanner 20 may gather any type of input data (e.g., a bar code, a two-dimensional bar code, an RFID tag, telemetric information, etc.).

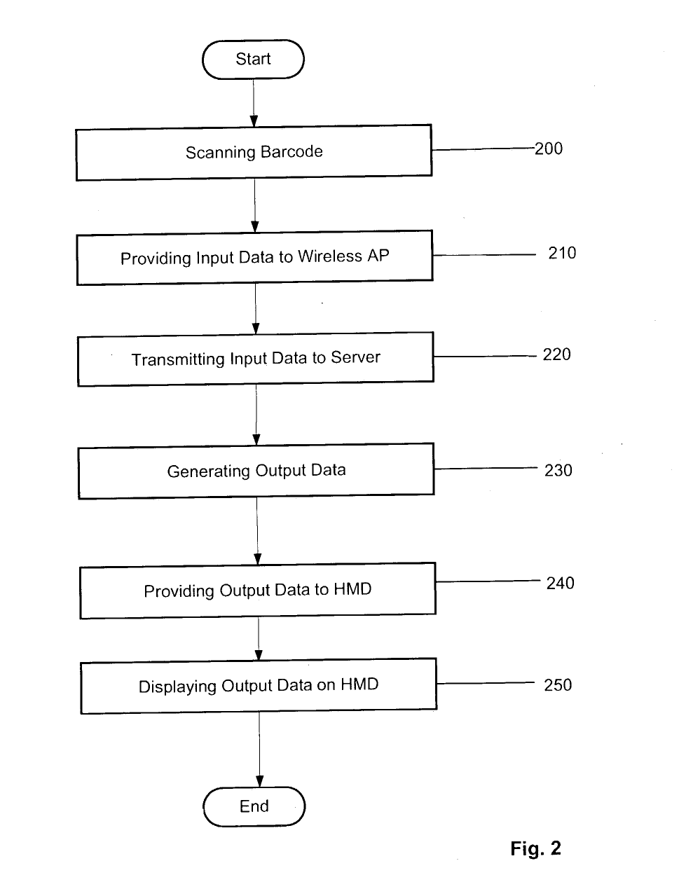

FIG. 2 shows an exemplary process according to the present invention. In this exemplary embodiment, the user obtains information via the ring scanner 20 and, in response, receive an output of relevant information on the display screen 15. First, the ring scanner 20 scans a barcode to obtain the input data 25 (step 200). The input data 25 is transmitted to the AP 30 via a first wireless transmission 110 (step 210). The AP 30, acting as a buffer, then transfers the input data 25, via the network 50, to the server 40 (step 220).

The server 40 processes the input data 25 to generate the output data (step 230). In particular, the input data 25 may be used as an index that enables the server 40 to retrieve the desired display information. Thus, the input data 25 is converted into display information (i.e., the output data) by the server 40.

The output data is then sent, via the network 50, to the AP 30 which forwards it to the HMD 10 via a second wireless transmission 120 (step 240). The output data may be either stored in the HMD 10 or may also be displayed to the user on the display screen 15 (step 250). In a further exemplary embodiment, the input data 25 may be displayed directly onto the display screen 15 or may be used to index information previously stored within the HMD 10.

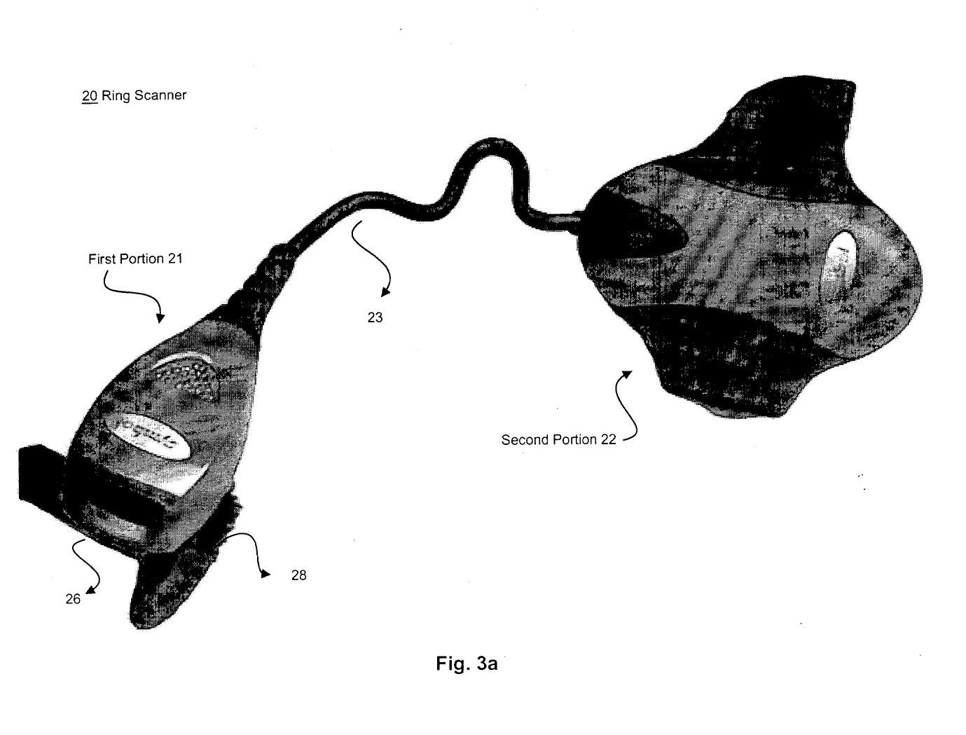

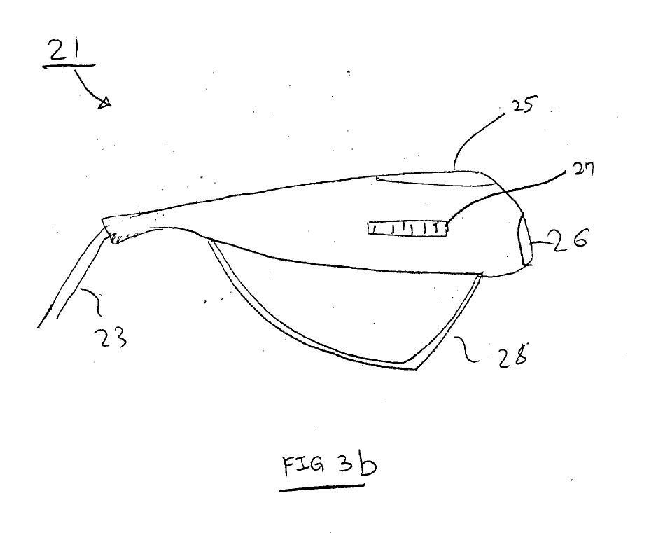

FIGS. 3a and 3b show an exemplary embodiment of the ring scanner 20 according to the present invention. The ring scanner 20 may consist of two parts: a first part 21 and a second part 22. The first and second parts 21, 22 may be connected via a cable 23.

The first part 21 may be attached to a finger using an attaching arrangement 28 (e.g., a velcro). The first part 21 has an opening 26 though which a scanner (not shown) reads the input data 25. For example, the first part 21 may include a single mode triggering mechanism 25 which activates the ring scanner 20. In another exemplary embodiment, the first part 21 may also include a ring scroll 27 (e.g., a knurled scroll, an activation knob, etc.) which allows the user to navigate the content on the display screen 15. The user may utilize the ring scroll 27 to select an individual item from a list of several items on the display screen 15.

The second part 22 may be attached to an arm of the user using an attachment arrangement 24 (e.g., velcro). The second part 22 receives the input data 25 via the cable 23 and processes it (e.g., decodes the bar code into a number). The second part 22 also may include a wireless transmitter which sends the input data 25 to the AP 30 using the first wireless transmission 110.

It is also possible that the ring scanner 20 be tracked, allowing simple hand motions to act as a means of navigation. This may be accomplished by utilizing (e.g., an image processor) (in the case of a video enabled ring), accelerometers within the ring scanner 20, and precise location tracking on radio frequencies emitted from the ring scanner 20 (e.g., ultra-wideband).

FIG. 4 shows an exemplary embodiment of the HMD 10. The HMD 10 may include the display screen 15 (e.g., a liquid crystal display (LCD)) which is attached to a frame 11 via an attaching arrangement 14. The frame 11 may situate electronic circuitry for the display screen 15, a wireless communication arrangement for communications with the AP 30, a power supply (e.g., batteries), a plurality of antennas, etc.

The frame 11 has two sides: sides 12a and 12b which are symmetrical about both sides of the user's head and allow an equal distribution of the payload on both side 12a, 12b. The frame 11 may be adjustable (e.g., elastic, velcro, adjusting strap) allowing for adjustments to varying head shapes and sizes such that each user is comfortable. In addition, the frame 11 may allow the HMD 10 to be placed on the user's head in such manner that the HMD 10 is prevented from unnecessarily moving and/or falling off the user's head. A further variation of the HMD 10 may be integrated with a head tracker. The head tracker may allow the HMD 10 to respond to the user's head movements.

The ergonomics of conventional HMD systems are often driven by the cabling (to a belt or other computer) and weight. Elimination of any cabling and the creation of a design that weighs only a few ounces (e.g., 3.52 ounces) enables the HMD 10 to have a back-of-the-neck ergonomic configuration. Unlike conventional systems that are placed over the head, the back-of-the-neck configuration is less visible and also more readily accepted by those concerned with their aesthetic appearance.

The HMD 10 is sufficiently light so as not to place an uncomfortable burden on the ears. The lightweight nature of the HMD 10 enables it to survive repeated drops without damage (e.g., when it is used in environmentally harsh business applications such as military maintenance programs).

Another important aspect of the HMD 10 is the display screen 15. The display screen 15 is also articulated to be adjustable in all dimensions. The display screen 15 refreshes the display contents locally (i.e., “pseudo-static”). Thus, unlike conventional systems, the display screen 15 is not updated on a frame-by-frame basis (i.e., video is not a primary mode of operation, though it may be supported at the expense of added memory and shortened battery life). The display screen 15 is designed to present relatively static reference material resulting from the data collection activity or telemetric information. The image often remains static for several seconds, and more commonly minutes, or possibly hours (e.g., text of a manual, assembly drawings, schematics, etc.).

The display buffer is integrated into the display controller, thus, decreasing power usage by reducing the number of external bus accesses (e.g., normally requiring power to drive the increase capacitive loading of external interconnects). The communications link to the HMD 10 needs no longer operate at the display refresh bandwidth. The link is no longer required to be synchronous (e.g., necessary to avoid buffering or frame jumps). Depending on where the information is stored, a link speed of several kilobits per second may be adequate.

The display screen 15 may be intermittently activated as needed; otherwise, it may be suspended in a low-power state. Several trigger events may activate the display screen 15. For example, an exemplary trigger event may be the reception of output data from the collection device.

Another exemplary trigger event may be a low power voice activity detector integrated into the frame 11. In addition, the voice activity detector may be combined with a voice verification so as to concurrently authenticate the user for secure access. A further exemplary trigger may be the position of the display screen 15. For instance, when the display screen 15 is moved in front of the eye, it may become armed; when moved out of view, it may be powered-down. Still a further exemplary trigger may be a simple momentary switch mounted on the display screen 15 which may be activated when tapped by the user. The suspended timeouts and event triggers may be configurable by the user off-line and downloaded via a wireless link.

Though a preferred mode of operation is to use a data collection peripheral to navigate the HMD 10, telemetric data may also be used (e.g., the HMD 10 acts as a user tracking device). In this exemplary mode of operation, the user wears an integrated or wireless peripheral device that indicates absolute or relative positions and optionally azimuth orientation (e.g., wireless Global Positioning System (“GPS”) with an electronic compass). The telemetric information may be used as a reference to access and present to the user location or orientation contextual information (e.g., maps or information about the user's current location context).

In this exemplary mode of operation, the HMD 10 may be equipped with an electronic compass (or equivalent) to determine the user's head orientation (e.g., azimuth direction). Using either communications-based wireless tracking or supplemental electronics, the user's absolute or relative position may be determined by the network infrastructure.

In an exemplary implementation of the present invention in such a mode of operation, a desired floor plan of an establishment (e.g., a retail store) may be loaded onto the server 40. When the user walks to a location in the establishment and looks in a particular direction, information on the user's position and orientation is sent to the server 40. The server 40, then uses this information to send to the user and displays on the display screen 15 an image and/or data on how the store should look from that particular position. If, for example, a cosmetic counter should be in view from that particular location and in that specific direction, then a picture of the desired format of the counter may be presented. As the user moves, the perspective changes accordingly, and the information received by the user on the display screen 15 changes in response as well.

A further exemplary implementation of the present invention may include its use at, e.g., a trade show. In such an exemplary situation, relevant information (e.g., information on new products, commercials, company history, etc.) may be shown for each individual vendor when the user focuses the HMD 10 in the direction of the vendor's booth.

Still a further exemplary implementation of the present invention may include the use of the HMD system 1 by employees in the retail industry. For example, an employee who provides fashion consultant services may utilize the system 1 to view inventory information and have it readily accessible during interactions with customers. Retail related information (e.g., inventory, matching accessories, complimentary clothing, etc.) is provided into the server 40 (e.g., this may be done by scanning all the bar codes associated with each item). If the customer would like to purchase a combination of clothing, such as a suit, the employee may first present a few necessary pieces (e.g., a jacket and pants). In order to find complimenting pieces of clothing (e.g., ties, shirts, etc.) and/or accessories, the employee scans the input data 25 (e.g., a bar code which may be on the tag of the suit). A list of suggestions and/or relevant inventory data appears on the display screen 15.

Still a further exemplary implementation of the present invention may be in conjunction with various forms of data collection. One such example may be a contact memory button reader (not shown). Contact memory devices are small read-only devices that are read by simple contact. Contact memories are currently being attached to or embedded into items such as aircraft parts and military rifles. In a sample application, a maintenance worker looking for information about an assembly simply touches the ring against the given component and the necessary information is received by the HMD 10 and may displayed on the display screen 15.

In still another exemplary implementation of the present invention, the HMD may incorporate an RFID interrogator using either a single directional antenna element or multiple elements to provide relative directionality.

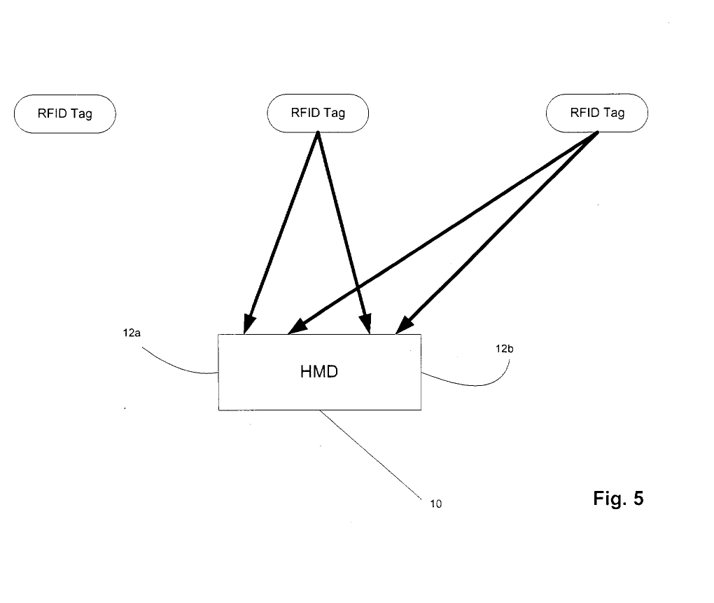

FIG. 5 shows an exemplary embodiment of the present invention incorporated with a plurality of RFID tags into the HMD 10. In the case of two antennas, each antenna is mounted on the sides 12a and 12b. Those skilled in the art would understand that more than two antennas may be utilized in the present invention. The tag is interrogated and the reply located by either time or phase difference or arrival. In a sample application the user simply looks at a shipping pallet, the HMD 10 detects that a tag is within the FoV, and the necessary information is presented.

Another advantage to the present invention is the mobility that results from the HMD being wireless. The user is able to have at least one hand free while using the HMD system 1. Yet another advantage to the present invention is the increased resolution and wide viewing angle allowing the user to more clearly visualize larger amounts of information than a PDA-type device.

Still another advantage to the present invention is the ergonomically efficient and comfortable design of the HMD 10. In addition, since the display screen does not block the user's entire face, the user may view the real world simultaneously to viewing the display screen. Also, the design allows for the use of eye glasses.

Still another advantage to the present invention is the minimized power usage. The static nature of the information allows the use of a high persistence display with low refresh rates (e.g., rates that are well below conventional rates of 70-80 Hz). This reduces the amount of power necessary and thus, allows the battery to be smaller in size and lighter in weight as well as extending the battery-life.

There are many modifications to the present invention which will be apparent to those skilled in the art without departing form the teaching of the present invention. The embodiments disclosed herein are for illustrative purposes only and are not intended to describe the bounds of the present invention which is to be limited only by the scope of the claims appended hereto.

What is claimed is:

1. A system for collecting and presenting data to a user, comprising:
a server including a memory storing predefined data;
a wireless portable data collector arrangement including a wireless communication device, a processor, a portable power supply and an input device, the input device collecting input data, the processor processing the input data and forwarding the input data to the server using the communication device which communicates with the server via a communication network, the data collector arrangement being situated on the user; and
a wireless portable head mounted display “HMD” arrangement receiving and storing output data and displaying at least a portion of the output data, the HMD arrangement communicating with at least one of the server and the data collector using the communication network,
wherein the server generates the output data as a function of the input data and the predefined data.

2. The system according to claim 1, further comprising:
a wireless access point coupled to the server, the access point supporting communications between the server and the HMD arrangement and the data collector.

3. The system according to claim 1, wherein the HMD arrangement includes a frame situated on a head of the user, a portable display displaying to the user at least a portion of the output data and coupled to the frame, an electronic circuitry, a buffer storing the output data, a wireless communication arrangement and a power supply.

4. The system according to claim 3, wherein the display is a pseudo-static low-power consuming display.

5. The system according to claim 3, wherein the HMD arrangement includes a head tracking arrangement situated in the frame, the head tracking arrangement collecting further input data, the further input data including user position data and user's azimuthal orientation data, the further input data being transmitted to the server, the output data being generated as a function at least one of the input data, the further input data and the predefined data.

6. The system according to claim 3, wherein the HMD arrangement includes a voice recognition arrangement situated in the frame, the voice recognition arrangement collecting further input data, the further input data including user voice commands, the further input data being transmitted to the server, the output data being generated as a function at least one of the input data, the further input data and the predefined data.

7. The system according to claim 1, wherein the input device is at least one of a barcode scanner, an imager and a Radio Frequency Identification Device tag reader.

8. The system according to claim 1, wherein the wireless communication device, the processor and the portable power supply are situated in a first part of the data collector arrangement, wherein the input device is situated in a second part of the data collector arrangment and wherein the first part and the second part are coupled to each other via a cable.

9. The system according to claim 8, wherein the first part is attached to the user's arm.

10. The system according to claim 8, wherein the second part is situated on the user's finger.

11. The system according to claim 8, wherein the data collector arrangement further includes a triggering mechanism situated in the second part, the triggering mechanism activating the input device.

12. The system according to claim 8, wherein the data collector arrangement further includes a ring scroll arrangement which is situated in the second part, the ring scroll arrangement allowing the user to at least one of navigate and select the portion of the output data to be displayed on the display.

13. The system according to claim 1, wherein the system is a user location tracking system.

14. A method for collecting and presenting data to a user, comprising the steps of:
collecting input data using a wireless portable data collector arrangement, the data collector arrangement including a wireless communication device, a processor, a portable power supply and an input device, the data collector arrangement being situated on the user;
processing of the input data and forwarding the input data by the processor to the server using the communication device which communicates with the server via a communication network;
generating output data by the server as a function of the input data and predefined data, the predefined data being stored in a memory of the server;
transferring the output data by the server to a wireless portable head mounted display “HMD” arrangement via the communication network;
receiving the output data and displaying at least a portion of the output data by the HMD arrangement.

15. The method according to claim 14, wherein the HMD arrangement includes a frame situated on a head of the user, a display displaying to the user at least a portion of the output data and coupled to the frame, an electronic circuitry, a buffer storing the output data, a wireless communication arrangement and a power supply.

16. The method according to claim 15, wherein the HMD arrangement includes a head tracking arrangement situated in the frame, and wherein the method further comprising the steps of:
using the head tracking arrangement collecting further input data, the further input data including user position data and user's azimuthal orientation data;
transmitting the further input data to the server; and
generating the output data as a function at least one of the input data, the further input data and the predefined data.

17. The method according to claim 15, wherein the HMD arrangement includes a voice recognition arrangement situated in the frame, and wherein the method further comprising the steps of:
using the voice recognition arrangement, collecting further input data, the further input data including user voice commands;
transmitting the further input data to the server; and
generating the output data as a function at least one of the input data, the further input data and the predefined data.

18. The method according to claim 14, wherein the input device includes at least one of a barcode scanner, an imager and a Radio Frequency Identification Device tag reader.

19. The method according to claim 14, wherein the wireless communication device, the processor and the portable power supply are situated in a first part of the data collector arrangement, wherein the input device is situated in a second part of the data collector arrangement and wherein the first part and the second part are coupled to each other via a cable.

20. The method according to claim 19, wherein the first part is attached to the user's arm.

21. The method according to claim 19, wherein the second part is situated on the user's finger.

22. The method according to claim 19, further comprising the step of:
activating the input device using a triggering mechanism of the data collector arrangement, the triggering mechanism being situated in the second part.

23. The method according to claim 19, further comprising the step of:
allowing the user to at least one of navigate and select the portion of the output data to be displayed on the display using a ring scroll arrangement of the data collector arrangement, the ring scroll arrangement being situated in the second part.
